(19) United States
(12) Patent Application Publication
(10) Pub. No.: US 2014/0048192 A1
(43) Pub. Date: Feb. 20, 2014

(54) PNEUMATIC TIRE

(71) Applicant: Sumitomo Rubber Industries, Ltd., Kobe-shi (JP)

(72) Inventors: Takahiro MABUCHI, Kobe-shi (JP); Koji FUJISAWA, Kobe-shi (JP); Mutsuki SUGIMOTO, Kobe-shi (JP)

(73) Assignee: Sumitomo Rubber Industries, Ltd., Kobe-shi (JP)

(21) Appl. No.: 13/948,656

(22) Filed: Jul. 23, 2013

(30) Foreign Application Priority Data
Aug. 15, 2012 (JP) 2012-180063
Aug. 23, 2012 (JP) 2012-184350

(51) Int. Cl. B60C 5/12

(52) U.S. Cl. CPC B60C 1/0008
USPC 152/510

(57) ABSTRACT

Provided is a pneumatic tire including an inner liner on a tire inner side of a carcass ply laid between a pair of bead parts, the inner liner having a first layer made of a first polymer composition, the first polymer composition containing not less than 0.5 parts by mass and not more than 70 parts by mass of at least one selected from the group consisting of liquid polyisoprene, a maleic anhydride adduct of liquid polyisoprene, and a maleic acid monomethyl ester adduct of liquid polyisoprene, relative to 100 parts by mass of a styrene-isobutylene-styrene triblock copolymer.

This nonprovisional application is based on Japanese Patent Application No. 2012-180063 filed on Aug. 15, 2012 and No. 2012-184350 filed on Aug. 23, 2012 with the Japan Patent Office, the entire contents of which are hereby incorporated by reference.

### BACKGROUND OF THE INVENTION

1. Field of the Invention

The present invention relates to a pneumatic tire, and more particularly to a pneumatic tire including an inner liner excellent in adhesiveness and air permeation resistance.

Further, the present invention relates to a pneumatic tire including an inner liner, and in particular to a pneumatic tire which reduces crack growth in the inner liner due to repeated flex deformation during driving of the tire, alleviates a reduction in the internal pressure of the tire, and decreases rolling resistance.

2. Description of the Background Art

An inner liner is arranged inside a tire, and has a function of reducing the amount of leakage of air from the inside to the outside of a pneumatic tire (a reduction in internal air pressure) and improving air permeation resistance. Recently, weight saving of tires has been pursued because of strong social demands for fuel efficiency of automobiles, and weight saving has also been pursued in inner liners.

At present, for a rubber composition for inner liners, rubber formulation mainly composed of butyl rubber (hereinafter also referred to as butyl-based rubber) which contains, for example, 70 to 100% by mass of butyl rubber and 30 to 0% by mass of natural rubber is used to improve air permeation resistance of tires. Further, the butyl-based rubber contains, in addition to butylene, about 1% by mass of isoprene, which allows crosslinking between rubber molecules along with sulfur, a vulcanization accelerator, and zinc white. When an inner liner is fabricated using the butyl-based rubber, it is required to have a thickness of about 0.6 to 1.0 mm for tires for passenger cars, and a thickness of about 1.0 to 2.0 mm for tires for trucks and buses. To pursue weight saving of tires, there has been a demand for a polymer which is more excellent in air permeation resistance and allows a further reduction in the thickness of an inner liner layer, when compared with the butyl-based rubber.

To pursue weight saving of tires, a material containing a thermoplastic resin instead of butyl-based rubber has been proposed as a composition for inner liners. However, when a tire is manufactured using an inner liner made of the material containing a thermoplastic resin, the inner liner partially becomes significantly thin due to a pressure in the vulcanization step. Thus, the finish gauge of the inner liner in the tire becomes thinner than the designed gauge. Since carcass cords stand out at a portion where the inner liner is thin (i.e., open threads), a user has an impression that the tire has a poor appearance. Further, a thin inner liner may cause partial deterioration of air permeation resistance, a reduction in the internal pressure of the tire, and, in the worst case, burst of the tire.

In addition, a large shear strain is imposed in the vicinity of a shoulder part of the inner liner while a vehicle is driving. When a film containing a thermoplastic resin is used as an inner liner, peeling-off is likely to occur at an adhesion interface between the inner liner and a carcass ply due to shear strain, causing leakage of air from the tire.

To pursue weight saving of inner liners, a technique using a material containing a thermoplastic elastomer has also been proposed. However, it has been found that the material, which is thinner and has a higher air permeation resistance than an inner liner made of butyl-based rubber, is inferior to the inner liner made of butyl-based rubber in vulcanization adhesive strength with insulation rubber and carcass ply rubber adjacent to the inner liner.

When the inner liner has a small vulcanization adhesive strength, an air-in phenomenon occurs, in which small air bubbles appear due to entrance of air between the inner liner and the insulation rubber or the carcass ply rubber. Since there are a number of small spots inside the tire, a user has an impression that the tire has a poor appearance. Further, peeling-off of the inner liner from the insulation rubber or the carcass ply rubber starting from the air may occur while the vehicle is driving, which may cause a crack in the inner liner, a reduction in the internal pressure of the tire, and, in the worst case, burst of the tire.

Japanese Patent Laying-Open No. 2007-291256 proposes a pneumatic tire capable of suppressing a reduction in air pressure, improving durability, and improving fuel efficiency at the same time, produced using, as an inner liner layer, a rubber composition for an inner liner at least containing 15 to 30 parts by mass of an ethylene-vinyl alcohol copolymer expressed by the following general formula (I):

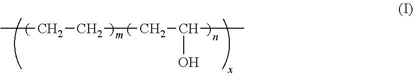

(where m and n are each 1 to 100 independently, and x is 1 to 1000), relative to 100 parts by mass of a rubber component made of natural rubber and/or synthetic rubber. However, in the technique described in Japanese Patent Laying-Open No. 2007-291256, a rubber sheet using the rubber composition has a thickness of 1 mm, and there is room for improvement in terms of weight saving of tires.

Japanese Patent Laying-Open No. 9-165469 proposes a pneumatic tire capable of improving adhesiveness of an inner liner layer formed using nylon having a low air permeation rate, with a tire inner surface or a carcass layer as a rubber composition. However, in the technique described in Japanese Patent Laying-Open No. 9-165469, it is necessary to subject a nylon film to RFL treatment and thereafter apply rubber cement made of a rubber composition to the nylon film in order to form a nylon film layer, which results in a complicated process.

Japanese Patent Laying-Open No. 2010-13646 proposes improving adhesive strength by using petroleum resin or terpene resin as a tackifier, for SIBS as a thermoplastic elastomer. However, a polyamid-based polymer is blended in addition to the SIBS, causing a reduction in flex crack resistance.

Further, Japanese Patent Laying-Open No. 2010-100675 proposes improving adhesiveness with carcass ply rubber by using natural rosin, terpene, chromane indene resin, petroleum resin, alkylphenol resin, or the like as a tackifier, for a blended material of SIBS and a sulfur-crosslinkable polymer.

However, in the technique of blending 10 to 300 parts by weight of the sulfur-crosslinkable polymer relative to 100 parts by weight of the SIBS, when the sulfur-crosslinkable polymer is not more than 100 parts by weight, the SIBS serves as a matrix (sea portion) and the sulfur-crosslinkable polymer serves as a domain structure (island portion), and adhesive strength with the carcass ply rubber at a contact interface is not improved. Further, when the sulfur-crosslinkable polymer is not less than 100 parts by weight, gas barrier property is deteriorated in other than butyl rubber, and adhesive strength is deteriorated in butyl rubber. In addition, depending on a polymer to be blended, tackiness is increased, and it is not possible to fabricate a film with a thickness of not more than 600 μm.

In International Publication No. 2008/029781, a tire is manufactured using strips of a film laminate obtained by blending a thermoplastic resin with a thermoplastic elastomer. By employing a laminate, gas barrier property and adhesiveness can be improved, which enables junction between the ribbon-shaped strips. However, in this technique, an unvulcanized green cover of the film laminate has a constant gauge, and if the gauge is thinned, a vulcanized tire may have a thinned finish at a buttress part or the like.

### SUMMARY OF THE INVENTION

One object of the present invention is to provide a pneumatic tire which includes an inner liner excellent in adhesiveness with adjacent rubber, and which is excellent in air permeation resistance and flex crack growth resistance.

Another object of the present invention is to provide a pneumatic tire including an inner liner, which alleviates a reduction in the internal pressure of the tire, reduces crack growth in the inner liner due to repeated flex deformation associated with driving of the tire, and decreases rolling resistance.

The present invention is directed to a pneumatic tire including an inner liner on a tire inner side of a carcass ply laid between a pair of bead parts, the inner liner having a first layer made of a first polymer composition, the first polymer composition containing not less than 0.5 parts by mass and not more than 70 parts by mass of at least one selected from the group consisting of liquid polyisoprene, a maleic anhydride adduct of liquid polyisoprene, and a maleic acid monomethyl ester adduct of liquid polyisoprene, relative to 100 parts by mass of a styrene-isobutylene-styrene triblock copolymer.

The present invention is directed to a pneumatic tire including an inner liner on a tire inner side of a carcass ply laid between a pair of bead parts, the inner liner having a first layer made of a first polymer composition and a second layer made of a second polymer composition, the first polymer composition containing not less than 0.5 parts by mass and not more than 35 parts by mass of at least one selected from the group consisting of liquid polyisoprene, a maleic anhydride adduct of liquid polyisoprene, and a maleic acid monomethyl ester adduct of liquid polyisoprene, relative to 100 parts by mass of a styrene-isobutylene-styrene triblock copolymer, the second polymer composition containing not less than 10% by mass and not more than 80% by mass of a styrene-isobutylene-styrene triblock copolymer in a polymer component, the second layer being arranged to contact the carcass ply.

Preferably, in the pneumatic tire in accordance with the present invention, the second polymer composition contains at least one of a styrene-isoprene-styrene triblock copolymer and a styrene-isobutylene diblock copolymer.

Preferably, in the pneumatic tire in accordance with the present invention, the number of maleic acid monomethyl esters per molecule in the maleic acid monomethyl ester adduct of liquid polyisoprene is not less than 1 and not more than 20, and the maleic acid monomethyl ester adduct of liquid polyisoprene has a weight-average molecular weight of not less than 5,000 and not more than 50,000.

Preferably, in the pneumatic tire in accordance with the present invention, the number of maleic anhydrides per molecule in the maleic anhydride adduct of liquid polyisoprene is not less than 1 and not more than 20, and the maleic anhydride adduct of liquid polyisoprene has a weight-average molecular weight of not less than 5,000 and not more than 50,000.

The present invention is directed to a pneumatic tire including an inner liner on a tire inner side of a carcass ply laid between a pair of bead parts, the inner liner including a first layer arranged on the tire inner side and a second layer arranged to contact a rubber layer of the carcass ply. The first layer is made of a first thermoplastic elastomer composition, the first thermoplastic elastomer composition containing not less than 90% by mass of a styrene-isobutylene-styrene triblock copolymer in a thermoplastic elastomer component, and containing not less than 0.1 parts by mass and not more than 35 parts by mass of liquid polyisoprene having a carboxyl group and not less than 0.1 parts by mass and not more than 10 parts by mass of imidazoles, relative to 100 parts by mass of the thermoplastic elastomer component. The second layer is made of a second thermoplastic elastomer composition, the second thermoplastic elastomer composition containing not less than 10% by mass and not more than 80% by mass of a styrene-isobutylene-styrene triblock copolymer in a thermoplastic elastomer component, and containing not less than 5 parts by mass and not more than 30 parts by mass of epoxidized diene-based rubber relative to 100 parts by mass of the thermoplastic elastomer component.

Preferably, in the pneumatic tire in accordance with the present invention, the imidazoles are 2-methylimidazole.

Preferably, in the pneumatic tire in accordance with the present invention, the second thermoplastic elastomer composition contains at least one of a styrene-isoprene-styrene triblock copolymer and a styrene-isobutylene diblock copolymer.

Preferably, in the pneumatic tire in accordance with the present invention, the first layer has a thickness of not less than 0.05 mm and not more than 0.6 mm, and the second layer has a thickness of not less than 0.01 mm and not more than 0.3 mm.

Preferably, in the pneumatic tire in accordance with the present invention, the styrene-isobutylene-styrene triblock copolymer has a styrene component content of not less than 10% by mass and not more than 30% by mass, and a weight-average molecular weight of not less than 50,000 and not more than 400,000.

Preferably, in the pneumatic tire in accordance with the present invention, the styrene-isoprene-styrene triblock copolymer has a styrene component content of not less than 10% by mass and not more than 30% by mass, and a weight-average molecular weight of not less than 100,000 and not more than 290,000.

Preferably, in the pneumatic tire in accordance with the present invention, the styrene-isobutylene diblock copolymer has a linear chain, a styrene component content of not less than 10% by mass and not more than 35% by mass, and a weight-average molecular weight of not less than 40,000 and not more than 120,000.

According to the present invention, a pneumatic tire which includes an inner liner excellent in adhesiveness with adjacent rubber, and which is excellent in air permeation resistance and flex crack growth resistance can be obtained.

Further, the pneumatic tire in accordance with the present invention can alleviate a reduction in the internal pressure of the tire, reduce crack growth in the inner liner due to repeated flex deformation associated with driving of the tire, and decrease rolling resistance.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic cross sectional view of the right half of a pneumatic tire in one embodiment of the present invention.

FIG. 2 is a schematic cross sectional view showing a state of arrangement of an inner liner and a carcass in one embodiment of the present invention.

FIG. 3 is a schematic cross sectional view showing a state of arrangement of an inner liner and a carcass in one embodiment of the present invention.

### DESCRIPTION OF THE PREFERRED EMBODIMENTS

### Embodiment 1

<Structure of Pneumatic Tire>

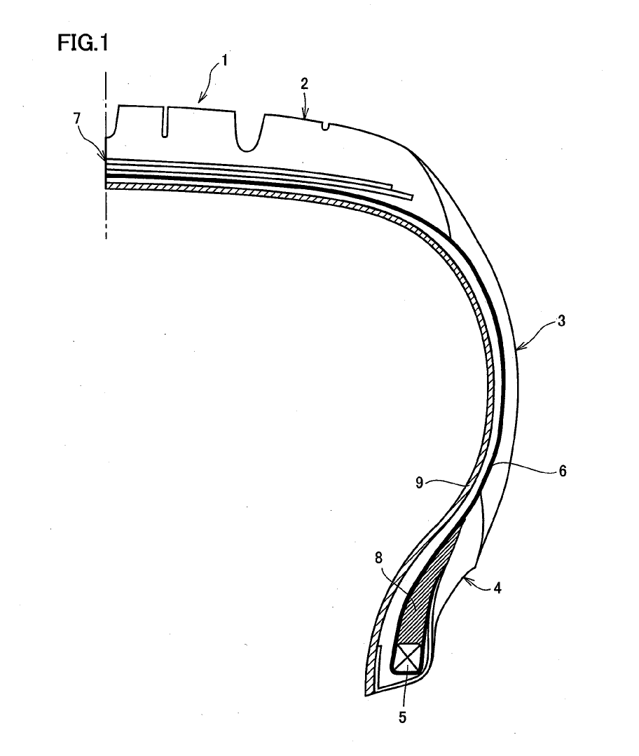

A structure of a pneumatic tire in one embodiment of the present invention will be described with reference to FIG. 1. FIG. 1 is a schematic cross sectional view of the right half of the pneumatic tire. A pneumatic tire 1 has a tread part 2, and a sidewall part 3 and a bead part 4 forming a toroidal shape from both ends of the tread part. Further, a bead core 5 is embedded in bead part 4. Also provided are a carcass ply 6 arranged to extend from one bead part 4 to the other bead part with each of both ends being folded back around bead core 5 and locked, and a belt layer 7 composed of at least two plies on an outer side of carcass ply 6 at a crown part.

The two plies of belt layer 7, each being made of a steel cord or a cord of aramid fiber or the like, are usually arranged so that the cords intersect with each other between the plies and each form an angle of usually 5 to 30° with respect to a tire circumferential direction. A topping rubber layer can be provided on an outer side of each of both ends of the belt layer to reduce peeling-off at the both ends of the belt layer. Regarding the carcass ply, organic fiber cords made of polyester, nylon, aramid or the like are arranged at an angle of about 90° with respect to the tire circumferential direction, and a bead apex 8 extending from the top end of bead core 5 toward the sidewall is arranged in a region surrounded by the carcass ply and the folded part thereof. An inner liner 9 extending from one bead part 4 to the other bead part 4 is arranged on a tire radial inner side of carcass ply 6. Pneumatic tire 1 is characterized by using an inner liner described below, as inner liner 9.

<Inner Liner Composed of First Layer>

In one embodiment of the present invention, the inner liner is composed of a first layer made of a first polymer composition.

(First Layer)

The first polymer composition used for the first layer contains not less than 0.5 parts by mass and not more than 70 parts by mass of at least one selected from the group consisting of liquid polyisoprene (hereinafter also referred to as “LIR”), a maleic acid monomethyl ester adduct of liquid polyisoprene (hereinafter also referred to as “maleic acid-modified LIR”), and a maleic anhydride adduct of liquid polyisoprene (hereinafter also referred to as “maleic anhydride-modified LIR”), relative to 100 parts by mass of a styrene-isobutylene-styrene triblock copolymer (hereinafter also referred to as “SIBS”).

(Styrene-Isobutylene-Styrene Triblock Copolymer)

Since the SIBS is derived from an isobutylene block, the polymer composition containing the SIBS has excellent air permeation resistance. Therefore, when the polymer composition containing the SIBS is used for the inner liner, a pneumatic tire having excellent air permeation resistance can be obtained.

Further, the SIBS has excellent durability since a molecular structure other than those of aromatic molecules is completely saturated and therefore deterioration and hardening are suppressed. Therefore, when the polymer composition containing the SIBS is used for the inner liner, a pneumatic tire having excellent durability can be obtained.

When a pneumatic tire is manufactured by using the polymer composition containing the SIBS for the inner liner, air permeation resistance can be ensured. Therefore, it is not necessary to use halogenated rubber having high specific gravity such as halogenated butyl rubber, which has been conventionally used to impart air permeation resistance, and even if the halogenated rubber is used, the amount of use can be reduced. This enables weight saving of the tire and improves fuel efficiency.

Although there is no particular limitation on the molecular weight of the SIBS, the weight-average molecular weight obtained by GPC measurement is preferably not less than 50,000 and not more than 400,000 in view of fluidity, molding step, rubber elasticity, and the like. When the weight-average molecular weight is less than 50,000, tensile strength and tensile elongation may decrease. When the weight-average molecular weight is more than 400,000, fluidity and moldability may deteriorate. Therefore, both the cases are not preferred.

Since the SIBS further improves air permeation resistance and durability, the content of a styrene component in the SIBS is preferably not less than 10% by mass and not more than 30% by mass, more preferably not less than 14% by mass and not more than 23% by mass.

In the SIBS as a copolymer, the polymerization degree of each block is preferably about 10,000 to 150,000 for isobutylene and about 5,000 to 30,000 for styrene, in view of rubber elasticity and handling (when the polymerization degree is less than 10,000, the SIBS becomes a liquid).

In the SIBS, the molar ratio between an isobutylene component and the styrene component (isobutylene component/styrene component) is preferably 40/60 to 95/5, in view of the rubber elasticity of the copolymer.

The SIBS can be obtained by a conventional living cationic polymerization method for a vinyl-based compound. For example, Japanese Patent Laying-Open No. 62-048704 and Japanese Patent Laying-Open No. 64-062308 disclose that living cationic polymerization of isobutylene with other vinyl compounds can be performed, and a polyisobutylene-based block copolymer can be manufactured by using isobutylene and other compounds as the vinyl compounds.

Since the SIBS does not have a double bond other than an aromatic double bond in a molecule, it has ultraviolet stability higher than that of a polymer having a double bond in a molecule, for example, polybutadiene, and thus has good weatherability. Further, although the SIBS does not have a double bond in a molecule and is a saturated rubber-like polymer, it has a refractive index (nD) of 1.506 for light with a wavelength of 589 nm at 20° C., according to “Polymer Handbook” (Wiley, 1989). This is significantly higher than that of other saturated rubber-like polymers, for example, an ethylene-butene copolymer.

(Liquid Polyisoprene)

In one embodiment of the present invention, the first polymer composition can contain liquid polyisoprene. Liquid polyisoprene is expressed by the following formula (II):

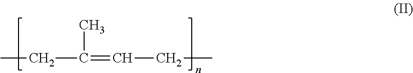

Liquid polyisoprene has a property that it is excellent in vulcanization adhesiveness. Therefore, by compounding liquid polyisoprene with the SIBS, a polymer composition for an inner liner excellent in vulcanization adhesiveness with an adjacent rubber layer can be obtained.

In liquid polyisoprene, the weight-average molecular weight obtained by GPC measurement is preferably not less than 5,000 and not more than 50,000 in view of adhesiveness after vulcanization and fluidity. The weight-average molecular weight is more preferably not less than 10,000 and not more than 40,000.

The content of liquid polyisoprene in the first polymer composition is not less than 0.5 parts by mass and not more than 70 parts by mass relative to 100 parts by mass of the SIBS. When the content of liquid polyisoprene is not less than 0.5 parts by mass, an inner liner excellent in adhesiveness with adjacent rubber can be obtained. In addition, when the content of liquid polyisoprene is not more than 70 parts by mass, a sufficient content of the SIBS in the polymer composition can be ensured, and thus an inner liner having excellent air permeation resistance and flex crack resistance can be obtained. More preferably, the content of liquid polyisoprene is not less than 2 parts by mass and not more than 45 parts by mass relative to 100 parts by mass of the SIBS.

(Maleic Acid Monomethyl Ester Adduct of Liquid Polyisoprene)

In one embodiment of the present invention, the first polymer composition can contain a maleic acid monomethyl ester adduct of liquid polyisoprene. Maleic acid-modified LIR is expressed by the following formula (III):

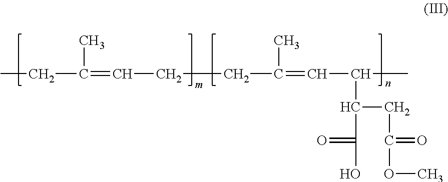

Although the ratio between m and n and the numbers thereof are not particularly limited in formula (III), they are preferably, for example, m/n=1 to 750, m=20 to 750, n=1 to 20, in view of adhesiveness after vulcanization and fluidity.

Maleic acid-modified LIR has a property that it is excellent in vulcanization adhesiveness. Therefore, by compounding maleic acid-modified LIR with the SIBS, a polymer composition for an inner liner excellent in vulcanization adhesiveness with an adjacent rubber layer can be obtained.

In maleic acid-modified LIR, the weight-average molecular weight obtained by GPC measurement is preferably not less than 5,000 and not more than 50,000 in view of adhesiveness after vulcanization and fluidity. The weight-average molecular weight is more preferably not less than 10,000 and not more than 40,000.

The content of maleic acid-modified LIR in the first polymer composition is not less than 0.5 parts by mass and not more than 70 parts by mass relative to 100 parts by mass of the SIBS. When the content of maleic acid-modified LIR is not less than 0.5 parts by mass, an inner liner excellent in adhesiveness with adjacent rubber can be obtained. In addition, when the content of maleic acid-modified LIR is not more than 70 parts by mass, a sufficient content of the SIBS in the polymer composition can be ensured, and thus an inner liner having excellent air permeation resistance and flex crack resistance can be obtained. More preferably, the content of maleic acid-modified LIR is not less than 2 parts by mass and not more than 45 parts by mass relative to 100 parts by mass of the SIBS.

(Maleic Anhydride Adduct of Liquid Polyisoprene)

In one embodiment of the present invention, the first polymer composition can contain a maleic anhydride adduct of liquid polyisoprene. Maleic anhydride-modified LIR is expressed by the following formula (IV):

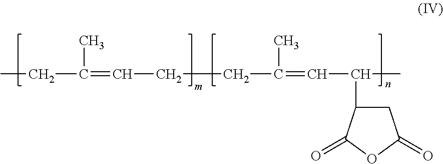

Although the ratio between m and n and the numbers thereof are not particularly limited in formula (IV), they are preferably, for example, m/n=1 to 750, m=20 to 750, n=1 to 20, in view of adhesiveness after vulcanization and fluidity.

Maleic anhydride-modified LIR has a property that it is excellent in vulcanization adhesiveness. Therefore, by compounding maleic anhydride-modified LIR with the SIBS, a polymer composition for an inner liner excellent in vulcanization adhesiveness with an adjacent rubber layer can be obtained.

In maleic anhydride-modified LIR, the weight-average molecular weight obtained by GPC measurement is preferably not less than 5,000 and not more than 50,000 in view of adhesiveness after vulcanization and fluidity. The weight-average molecular weight is more preferably not less than 10,000 and not more than 40,000.

The content of maleic anhydride-modified LIR in the first polymer composition is not less than 0.5 parts by mass and not more than 70 parts by mass relative to 100 parts by mass of the SIBS. When the content of maleic anhydride-modified LIR is not less than 0.5 parts by mass, an inner liner excellent in adhesiveness with adjacent rubber can be obtained. In addition, when the content of maleic anhydride-modified LIR is not more than 70 parts by mass, a sufficient content of the SIBS in the polymer composition can be ensured, and thus an inner liner having excellent air permeation resistance and flex crack resistance can be obtained. More preferably, the content of maleic anhydride-modified LIR is not less than 2 parts by mass and not more than 45 parts by mass relative to 100 parts by mass of the SIBS.

It is noted that, in one embodiment of the present invention, the first polymer composition can contain two or more selected from the group consisting of liquid polyisoprene, maleic acid-modified LIR, and maleic anhydride-modified LIR. In this case, the total content of liquid polyisoprene, maleic acid-modified LIR, and maleic anhydride-modified LIR is not less than 0.5 parts by mass and not more than 70 parts by mass relative to 100 parts by mass of the SIBS.

(Thickness of First Layer)

The thickness of the first layer is preferably not less than 0.05 mm and not more than 0.6 mm. When the thickness of the first layer is less than 0.05 mm, the first layer may be broken by a pressing pressure during vulcanization of a green tire in which the first layer is used as the inner liner, and thus an air leak phenomenon may occur in the resultant tire. On the other hand, when the thickness of the first layer is more than 0.6 mm, tire weight increases and fuel efficiency performance deteriorates. The thickness of the first layer is more preferably not less than 0.05 mm and not more than 0.4 mm.

(Other Compounding Agents)

Other various compounding agents and additives to be compounded with a polymer composition for tires or for general use, such as a reinforcer, a vulcanizer, a vulcanization accelerator, various oils, an antioxidant, a softener, a plasticizer, a coupling agent, and the like, can be compounded with the first polymer composition. Further, the contents of these compounding agents and additives can be set to common amounts.

<Method for Manufacturing Inner Liner>

The inner liner composed of the first layer can be manufactured by subjecting various compounding agents of the first polymer composition to a conventional method of forming a styrene-based thermoplastic elastomer into a film, such as extrusion molding or calender molding

<Method for Manufacturing Pneumatic Tire>

The pneumatic tire in accordance with the present invention can be manufactured using the inner liner described above for a green tire, by vulcanization-molding the inner liner together with other members.

The first polymer composition constituting the inner liner is a composition containing a thermoplastic elastomer, and is in a softened state in a mold at a vulcanization temperature, for example 150° C. to 180° C. The softened state refers to an intermediate state between a solid and a liquid with improved molecular mobility. A thermoplastic elastomer composition in the softened state tends to adhere to or be bonded with an adjacent member. Accordingly, in order to manufacture a tire, a cooling step is required to prevent a change in the shape of the thermoplastic elastomer and its adhesion or fusion to the adjacent member. In the cooling step, the inside of a bladder is cooled rapidly to 50 to 120° C. for 10 to 300 seconds after vulcanization of the tire. As a cooling medium, at least one selected from air, steam, water, and oil is used. By adopting such a cooling step, the inner liner can have a thin thickness.

### Embodiment 2

<Structure of Pneumatic Tire>

A pneumatic tire in the present embodiment can have a structure similar to that in Embodiment 1. In the present embodiment, an inner liner used for the pneumatic tire includes a first layer made of a first polymer composition and a second layer made of a second polymer composition.

<First Layer>

As the first layer, the one similar to the first layer described in Embodiment 1 can be used.

It is noted that the first polymer composition contains not less than 0.5 parts by mass and not more than 35 parts by mass of at least one selected from the group consisting of liquid polyisoprene, a maleic anhydride adduct of liquid polyisoprene, and a maleic acid monomethyl ester adduct of liquid polyisoprene, relative to 100 parts by mass of a styrene-isobutylene-styrene triblock copolymer. When the content of LIR, maleic acid-modified LIR, or maleic anhydride-modified LIR is less than 0.5 parts by mass, sufficient adhesiveness with the second layer cannot be obtained. On the other hand, when the content thereof is more than 35 parts by mass, the effect of decreasing rolling resistance of the tire tends to be deteriorated.

<Second Layer>

The second polymer composition used for the second layer preferably contains not less than 10% by mass and not more than 80% by mass of a styrene-isobutylene-styrene triblock copolymer in a polymer component.

As the SIBS, the one identical to the SIBS described in Embodiment 1 can be used.

The content of the SIBS in the second polymer composition is preferably not less than 10% by mass and not more than 80% by mass in the polymer component. When the SIBS is less than 10% by mass, adhesiveness with the first layer is reduced, and when the SIBS is more than 80% by mass, adhesiveness with the carcass ply tends to be reduced.

Preferably, the second polymer composition contains another styrene-based thermoplastic elastomer, in addition to the SIBS. Here, a styrene-based thermoplastic elastomer refers to a copolymer containing a styrene block as a hard segment. Examples thereof include a styrene-isoprene-styrene triblock copolymer (hereinafter also referred to as “SIS”), a styrene-isobutylene diblock copolymer (hereinafter also referred to as “SIB”), a styrene-butadiene-styrene block copolymer (hereinafter also referred to as “SBS”), a styrene-ethylene-butene-styrene block copolymer (hereinafter also referred to as “SEBS”), a styrene-ethylene-propylene-styrene block copolymer (hereinafter also referred to as “SEPS”), a styrene-ethylene-ethylene-propylene-styrene block copolymer (hereinafter also referred to as “SEEPS”), and a styrene-butadiene-butylene-styrene block copolymer (hereinafter also referred to as “SBBS”).

Further, the styrene-based thermoplastic elastomer may have an epoxy group in its molecular structure, and for example an epoxy-modified styrene-butadiene-styrene copolymer (hereinafter also referred to as “epoxidized SBS”) such as Epofriend A1020 manufactured by Daicel Chemical Industries, Ltd. (weight-average molecular weight: 100,000; epoxy equivalent: 500) can be used.

Of the styrene-based thermoplastic elastomers, the styrene-isoprene-styrene triblock copolymer (SIS) and the styrene-isobutylene diblock copolymer (SIB) are particularly preferable for use.

(Styrene-Isoprene-Styrene Triblock Copolymer)

Since an isoprene block of the SIS is a soft segment, a polymer composition containing the SIS is easily vulcanization-bonded with a rubber component. Therefore, when the polymer composition containing the SIS is used for the inner liner, the inner liner is excellent in adhesiveness with rubber forming the carcass ply, and thus a pneumatic tire excellent in durability can be obtained.

Although there is no particular limitation on the molecular weight of the SIS, the weight-average molecular weight obtained by GPC measurement is preferably not less than 100,000 and not more than 290,000 in view of rubber elasticity and moldability. When the weight-average molecular weight is less than 100,000, tensile strength may decrease. When the weight-average molecular weight is more than 290,000, extrusion moldability may deteriorate. Therefore, both the cases are not preferred. The content of a styrene component in the SIS is preferably not less than 10% by mass and not more than 30% by mass in view of tackiness, adhesiveness, and rubber elasticity.

In the present invention, the polymerization degree of each block in the SIS is preferably about 500 to 5,000 for isoprene and about 50 to 1,500 for styrene, in view of rubber elasticity and handling.

The SIS can be obtained by a conventional polymerization method for a vinyl-based compound, and can be obtained, for example, by the living cationic polymerization method.

(Styrene-Isobutylene Diblock Copolymer)

Since an isobutylene block of the SIB is a soft segment, a polymer composition containing the SIB is easily vulcanization-bonded with a rubber component. Therefore, when the polymer composition containing the SIB is used for the inner liner, the inner liner is excellent in adhesiveness with adjacent rubber forming a carcass or an insulation, for example, and thus a pneumatic tire excellent in durability can be obtained.

It is preferable to use one having a linear chain as the SIB in view of rubber elasticity and adhesiveness. Although there is no particular limitation on the molecular weight of the SIB, the weight-average molecular weight obtained by GPC measurement is preferably not less than 40,000 and not more than 120,000 in view of rubber elasticity and moldability. When the weight-average molecular weight is less than 40,000, tensile strength may decrease. When the weight-average molecular weight is more than 120,000, extrusion moldability may deteriorate. Therefore, both the cases are not preferred.

The content of a styrene component in the SIB is preferably not less than 10% by mass and not more than 35% by mass in view of tackiness, adhesiveness, and rubber elasticity.

In the present invention, the polymerization degree of each block in the SIB is preferably about 300 to 3,000 for isobutylene and about 10 to 1,500 for styrene, in view of rubber elasticity and handling.

The SIB can be obtained by a conventional living polymerization method for a vinyl-based compound. For example, methylcyclohexane, n-butyl chloride, and cumyl chloride are charged in a stirrer, cooled to −70° C. and thereafter reacted for 2 hours, and then the reaction is terminated by adding a large amount of methanol, and the reaction product is vacuum-dried at 60° C. Thereby, the SIB can be manufactured.

<Thickness of Second Layer>

The thickness of the second layer is preferably not less than 0.01 mm and not more than 0.3 mm. When the thickness of the second layer is less than 0.01 mm, the second layer may be broken by a pressing pressure during vulcanization of a green tire in which the inner liner is arranged, and thus vulcanization adhesive strength may be reduced. On the other hand, when the thickness of the second layer is more than 0.3 mm, tire weight may increase and fuel efficiency performance may deteriorate. The thickness of the second layer is more preferably not less than 0.05 mm and not more than 0.2 mm.

<Method for Manufacturing Inner Liner>

The inner liner in the present embodiment can be manufactured by a method similar to the method for manufacturing the inner liner described in Embodiment 1.

<Method for Manufacturing Pneumatic Tire>

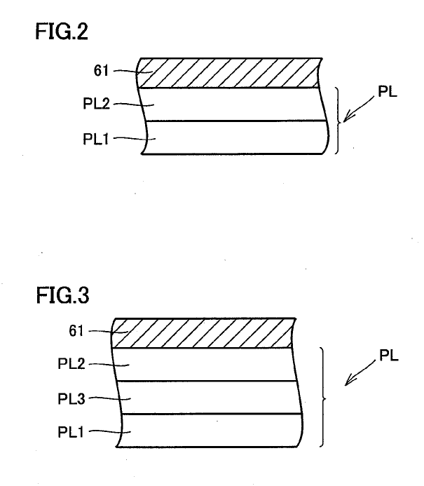

The pneumatic tire in the present embodiment can be manufactured by a method similar to the method for manufacturing the pneumatic tire described in Embodiment 1. It is noted that, when the inner liner is arranged in the green tire, the second layer is arranged toward a tire radial outer side so as to contact carcass ply 61. With such an arrangement, adhesive strength between the second layer and carcass ply 61 can be enhanced in the tire vulcanization step. The resultant pneumatic tire can have excellent air permeation resistance and durability, since the inner liner is satisfactorily bonded with the rubber layer of carcass ply 61. Hereinafter, a state of arrangement of the inner liner in the pneumatic tire will be described with reference to FIGS. 2 and 3.

In FIG. 2, an inner liner PL is composed of a first layer PL1 and a second layer PL2. When inner liner PL is used as the inner liner of the pneumatic tire, if second layer PL2 is arranged toward the tire radial outer side so as to contact carcass ply 61, adhesive strength between second layer PL2 and carcass ply 61 can be enhanced in the tire vulcanization step. Therefore, the resultant pneumatic tire can have excellent air permeation resistance and durability, since the inner liner is satisfactorily bonded with carcass ply 61.

In FIG. 3, inner liner PL has a film made of urethane rubber or silicone rubber, as a third layer PL3, between first layer PL1 and second layer PL2. When inner liner PL is used as the inner liner of the pneumatic tire, if a surface of second layer PL2 is arranged toward the tire radial outer side so as to contact carcass ply 61, adhesive strength between second layer PL2 and carcass ply 61 can be enhanced in the tire vulcanization step. Therefore, the resultant pneumatic tire can have excellent air permeation resistance and durability, since the inner liner is satisfactorily bonded with carcass ply 61.

### Embodiment 3

<Structure of Tire>

A pneumatic tire in the present embodiment can have a structure similar to that in Embodiment 1.

<Inner Liner>

In the present embodiment, an inner liner is composed of a first layer arranged on a tire inner side and a second layer arranged to contact a rubber layer of a carcass ply.

<First Layer>

The first layer is made of a first thermoplastic elastomer composition containing a styrene-isobutylene-styrene triblock copolymer (hereinafter also referred to as “SIBS”), liquid polyisoprene having a carboxyl group, and imidazoles.

(SIBS)

As the SIBS, the one identical to the SIBS described in Embodiment 1 can be used.

The first thermoplastic elastomer composition contains not less than 90% by mass of the SIBS in a thermoplastic elastomer component. When the content of the SIBS is less than 90% by mass, sufficient air permeation resistance performance cannot be obtained.

As the thermoplastic elastomer component, a styrene-based thermoplastic elastomer, a urethane-based thermoplastic elastomer, or the like can be used other than the SIBS.

(Liquid Polyisoprene Having Carboxyl Group)

The first thermoplastic elastomer composition contains not less than 0.1 parts by mass and not more than 35 parts by mass of liquid polyisoprene having a carboxyl group (hereinafter also referred to as “carboxyl group-modified LIR”), relative to 100 parts by mass of the thermoplastic elastomer component.

As carboxyl group-modified LIR, for example, a maleic acid monomethyl ester adduct of liquid polyisoprene (hereinafter also referred to as “maleic acid-modified LIR”), or a maleic anhydride adduct of liquid polyisoprene (hereinafter also referred to as “maleic anhydride-modified LIR”) can be used.

As maleic acid-modified LIR and maleic anhydride-modified LIR, those identical to the maleic acid-modified LIR and the maleic anhydride-modified LIR described in Embodiment 1 can be used.

Carboxyl group-modified LIR has a property that it is excellent in vulcanization adhesiveness. Thus, the first thermoplastic elastomer composition containing carboxyl group-modified LIR is excellent in adhesiveness with a second thermoplastic elastomer composition. Therefore, the first layer and the second layer can be satisfactorily bonded with each other in the inner liner to prevent occurrence of an air-in phenomenon between the first layer and the second layer, improving tire durability performance.

In carboxyl group-modified LIR, the weight-average molecular weight obtained by GPC measurement is preferably not less than 5,000 and not more than 50,000 in view of adhesiveness after vulcanization and fluidity. When the weight-average molecular weight is less than 5,000, viscosity decreases, mixing property with a thermoplastic elastomer deteriorates, and bleeding may occur. On the other hand, when the weight-average molecular weight is more than 50,000, sheet moldability deteriorates. The weight-average molecular weight is more preferably not less than 10,000 and not more than 40,000.

The content of carboxyl group-modified LIR in the first thermoplastic elastomer composition is not less than 0.1 parts by mass and not more than 35 parts by mass relative to 100 parts by mass of the thermoplastic elastomer component. When the content of carboxyl group-modified LIR is not less than 0.1 parts by mass, an inner liner excellent in adhesiveness between the first layer and the second layer can be obtained. In addition, when the content of carboxyl group-modified LIR is not more than 35 parts by mass, a sufficient content of the SIBS in the first thermoplastic elastomer composition can be ensured, and thus an inner liner having excellent air permeation resistance and flex crack resistance can be obtained. More preferably, the content of carboxyl group-modified LIR is not less than 2 parts by mass and not more than 15 parts by mass relative to 100 parts by mass of the first thermoplastic elastomer component.

(Imidazoles)

The first thermoplastic elastomer composition contains not less than 0.1 parts by mass and not more than 10 parts by mass of imidazoles, relative to 100 parts by mass of the thermoplastic elastomer component. When the content of imidazoles is more than 10 parts by mass, rolling resistance of the tire tends to be deteriorated. On the other hand, when the compounding amount of imidazoles is less than 0.1 parts by mass, sufficient adhesiveness with the second thermoplastic elastomer composition cannot be obtained.

Examples of imidazoles include imidazole, 1-methylimidazole, 2-methylimidazole, N-acetylimidazole, 2-mercapto-1-methylimidazole, benzimidazole, 2-mercaptobenzimidazole, 2-phenylimidazole, 1-benzyl-2-methylimidazole, and the like. Among them, 2-methylimidazole, imidazole, or 1-methylimidazole is preferably used, and 2-methylimidazole is particularly preferably used, because it has a simple structure, nitrogen is close to acid, and a hydrogen bond is easily formed.

The thickness of the first layer is preferably not less than 0.05 mm and not more than 0.6 mm. When the thickness of the first layer is less than 0.05 mm, the first layer may be broken by a pressing pressure during vulcanization of a green tire provided with the inner liner, and thus an air leak phenomenon may occur in the resultant tire. On the other hand, when the thickness of the first layer is more than 0.6 mm, tire weight increases and fuel efficiency performance deteriorates. The thickness of the first layer is more preferably not less than 0.05 mm and not more than 0.4 mm.

The first layer can be molded by subjecting the first thermoplastic elastomer composition to a conventional method of forming a thermoplastic elastomer into a film, such as extrusion molding or calender molding.

<Second Layer>

The second layer is made of a second thermoplastic elastomer composition containing a styrene-isobutylene-styrene triblock copolymer (SIBS) and epoxidized diene-based rubber.

As the SIBS, the one identical to that for the first layer can be used. Since the SIBS is compounded in the second layer, adhesiveness with the first layer is further improved, and bonding between the first layer and the second layer can be further strengthened.

The content of the SIBS in the second thermoplastic elastomer composition is not less than 10% by mass and not more than 80% by mass in a thermoplastic elastomer component. When the SIBS is less than 10% by mass, adhesiveness with the first layer is reduced, and when the SIBS is more than 80% by mass, adhesiveness with the carcass ply tends to be reduced. The content of the SIBS is more preferably not less than 30% by mass and not more than 70% by mass.

The second thermoplastic elastomer composition can contain another styrene-based thermoplastic elastomer composition, in addition to the SIBS. Here, a styrene-based thermoplastic elastomer composition refers to a copolymer containing a styrene block as a hard segment. Examples thereof include a styrene-isoprene-styrene triblock copolymer (hereinafter also referred to as “SIS”), a styrene-isobutylene diblock copolymer (hereinafter also referred to as “SIB”), a styrene-butadiene-styrene block copolymer (hereinafter also referred to as “SBS”), a styrene-ethylene-butene-styrene block copolymer (hereinafter also referred to as “SEBS”), a styrene-ethylene-propylene-styrene block copolymer (hereinafter also referred to as “SEPS”), a styrene-ethylene-ethylene-propylene-styrene block copolymer (hereinafter also referred to as “SEEPS”), and a styrene-butadiene-butylene-styrene block copolymer (hereinafter also referred to as “SBBS”).

Further, the styrene-based thermoplastic elastomer composition may have an epoxy group in its molecular structure, and for example an epoxy-modified styrene-butadiene-styrene copolymer (epoxidized SBS) such as Epofriend A1020 manufactured by Daicel Chemical Industries, Ltd. (weight-average molecular weight: 100,000; epoxy equivalent: 500) can be used.

Of the styrene-based thermoplastic elastomer compositions, the SIS and the SIB are particularly suitable for use.

(SIS)

As the SIS, the one identical to the SIS described in Embodiment 2 can be used.

(SIB)

As the SIB, the one identical to the SIB described in Embodiment 2 can be used.

(Epoxidized Diene-based Rubber)

The second thermoplastic elastomer composition contains not less than 5 parts by mass and not more than 30 parts by mass of epoxidized diene-based rubber, relative to 100 parts by mass of the thermoplastic elastomer component. When the content of epoxidized diene-based rubber is less than 5 parts by mass, the effect of improving adhesiveness cannot be fully obtained. On the other hand, when the content of epoxidized diene-based rubber is more than 30 parts by mass, rolling resistance tends to be deteriorated.

As epoxidized diene-based rubber, for example, epoxidized natural rubber can be used. As epoxidized natural rubber, commercially available epoxidized natural rubber may be used, or natural rubber may be used after being epoxidized. The method for epoxidizing natural rubber is not particularly limited, and a method such as chlorohydrin method, direct oxidation method, hydrogen peroxide method, alkyl hydroperoxide method, peracid method can be used. For example, a method of causing natural rubber to react with organic peracid such as peracetic acid or performic acid may be used.

Epoxidized natural rubber preferably has an epoxidation rate of preferably not less than 5 mol %, and more preferably not less than 10 mol %. Further, the epoxidation rate is preferably not more than 80 mol %, and more preferably not more than 60 mol %. When the epoxidation rate is more than 80 mol %, a polymer component turns into a gel, and thus is not preferable.

The thickness of the second layer is preferably not less than 0.01 mm and not more than 0.3 mm. When the thickness of the second layer is less than 0.01 mm, the second layer may be broken by a pressing pressure during vulcanization of the green tire provided with the inner liner, and thus vulcanization adhesive strength may be reduced. On the other hand, when the thickness of the second layer is more than 0.3 mm, tire weight may increase and fuel efficiency performance may deteriorate. The thickness of the second layer is more preferably not less than 0.05 mm and not more than 0.2 mm

The second layer can be molded by subjecting the second thermoplastic elastomer composition to a conventional method of forming a thermoplastic elastomer into a film, such as extrusion molding or calender molding.

<Arrangement of Inner Liner>

A state of arrangement of an inner liner and a carcass ply in a vulcanized tire will be illustrated in FIG. 2.

In FIG. 2, inner liner PL is composed of first layer PL1 and second layer PL2. When inner liner PL is used as the inner liner of the pneumatic tire, if second layer PL2 is arranged toward the tire radial outer side so as to contact carcass ply 61, adhesive strength between second layer PL2 and carcass ply 61 can be enhanced in the tire vulcanization step. Therefore, the resultant pneumatic tire can have excellent air permeation resistance and durability, since the inner liner is satisfactorily bonded with the rubber layer of carcass ply 61.

<Method for Manufacturing Inner Liner>

The inner liner can be manufactured, for example, by a method described below. The first layer and the second layer are fabricated by extrusion molding, calender molding, or the like. The first layer and the second layer are bonded with each other to fabricate the inner liner. The inner liner can also be fabricated by subjecting pellets of each of the first thermoplastic elastomer composition and the second thermoplastic elastomer composition to stacked extrusion such as laminate extrusion or coextrusion.

<Method for Manufacturing Pneumatic Tire>

The pneumatic tire in accordance with the present invention can be manufactured using an ordinary manufacturing method. The pneumatic tire can be manufactured using the inner liner described above for a green tire of pneumatic tire 1, by vulcanization-molding the inner liner together with other members.

When the inner liner is arranged in the green tire, the second layer is arranged toward the tire radial outer side so as to contact the carcass ply. With such an arrangement, adhesive strength between the second layer and the carcass ply can be enhanced in the tire vulcanization step. The resultant pneumatic tire can have excellent air permeation resistance and durability, since the inner liner is satisfactorily bonded with the rubber layer of the carcass ply.

In the present invention, the inner liner is composed of the first layer and the second layer. Here, the first layer and the second layer are each made of a thermoplastic elastomer composition, and are in a softened state in a mold at a vulcanization temperature, for example 150° C. to 180° C. The softened state refers to an intermediate state between a solid and a liquid with improved molecular mobility. Further, a thermoplastic elastomer composition in the softened state tends to adhere to or be bonded with an adjacent member. Accordingly, in order to manufacture a tire, a cooling step is required to prevent a change in the shape of a thermoplastic elastomer and its adhesion or fusion to the adjacent member. In the cooling step, the inside of a bladder is cooled rapidly to 50 to 120° C. for 10 to 300 seconds after vulcanization of the tire. As a cooling medium, at least one selected from air, steam, water, and oil is used. By adopting such a cooling step, a thin inner liner can be formed.

### Example 1

<Fabrication of Inner Liner>

According to each formulation shown in Table 1, compounding agents were charged into a twin-screw extruder (screw diameter: φ 50 mm; L/D: 30; cylinder temperature: 220° C.) to obtain pellets. Thereafter, a polymer sheet for an unvulcanized inner liner was fabricated with a T-die extruder (screw diameter: φ 80 mm; L/D: 50; die gap width: 500 mm; cylinder temperature: 220° C.; film gauge: 0.3 mm). The polymer sheet was used to perform the following tests.

<Peel-Off Strength Test>

An adhesive strength test was performed according to JIS K 6256 “Vulcanized Rubber and Thermoplastic Rubber—How to Obtain Adhesiveness”. First, the polymer sheet with a thickness of 0.3 mm, a rubber sheet with a thickness of 2 mm (formulation: NR/BR/SBR=40/30/30), and reinforced canvas were laminated in this order and subjected to heat and pressure at 170° C. for 12 minutes to fabricate a test piece for peel-off. The obtained test piece was used to perform a peel-off test, and adhesive strength between the polymer sheet for the inner liner and the rubber sheet was measured. The test piece had a width of 25 mm, and the test was performed at a room temperature of 23° C. Based on the following calculation equation, an adhesive strength index of each sample was calculated, using the value of sample 1 as a reference value (100). The greater the value is, the more excellent the adhesiveness is.

(adhesive strength index)=(adhesive strength of each sample)/(adhesive strength of sample 1)×100

Table 1 shows results.

<JIS-A Hardness>

According to JIS K 6253 “How to Obtain Hardness of Vulcanized Rubber and Thermoplastic Rubber”, each test piece was fabricated and its JIS-A hardness was measured at a room temperature of 23° C. Table 1 shows results.

<Fabrication of Tire>

The above polymer sheet for the inner liner was used for an inner liner part of a tire of 195/65R15 size having a structure of FIG. 1 to manufacture a green tire, and then press vulcanization was performed at 170° C. for 20 minutes in the vulcanization step. The tire was used to perform the following tests.

<Static Air Pressure Drop Rate Test>

A 195/65R15 steel radial PC tire was mounted on a JIS standard rim 15×6JJ, and an initial air pressure of 300 kPa was sealed therein. The tire was left at room temperature for 90 days and thereafter an air pressure drop rate was calculated. The smaller the value is, the more excellent the air permeation resistance is.

Table 1 shows results.

<Flex Crack Growth Test>

According to JIS K 6260 “De Mattia Flex Cracking Test Method for Vulcanized Rubber and Thermoplastic Rubber”, each test piece was fabricated, and a flex crack growth test was performed thereon. Each test piece was repeatedly expanded by 70% one million times to flex the rubber sheet, and thereafter the length of a crack which occurred therein was measured. Using the obtained value, flex crack growth resistance of each sample was expressed as an index based on the following equation, with the value of sample 1 being set as a reference value (100). The greater the value is, the less likely a crack is to grow, which is satisfactory.

(flex crack growth resistance index)=(length of a crack in sample 1)/(length of a crack in each sample)×100

Table 1 shows results.

TABLE 1

| | | Compounding agent | Sample | | | | | | | | | | |
|---|---|---|---|---|---|---|---|---|---|---|---|---|---|
| | | (parts by mass) | 1 | 2 | 3 | 4 | 5 | 6 | 7 | 8 | 9 | 10 | 11 |
| Inner | First | IIR⁽*¹⁾ | 100 | — | — | — | — | — | — | — | — | — | — |
| liner | layer | SIBS⁽*²⁾ | — | 100 | 95.5 | 80 | 60 | 95.5 | 80 | 60 | 95.5 | 80 | 60 |
| | | LIR(1)⁽*³⁾ | — | — | 0.5 | 20 | 40 | — | — | — | — | — | — |
| | | LIR(2)⁽*⁴⁾ | — | — | — | — | — | 0.5 | 20 | 40 | — | — | — |
| | | LIR(3)⁽*⁵⁾ | — | — | — | — | — | — | — | — | 0.5 | 20 | 40 |
| | | Carbon⁽*⁶⁾ | 60 | — | — | — | — | — | — | — | — | — | — |

| | | | | | | | | | | | | |
|---|---|---|---|---|---|---|---|---|---|---|---|---|
| Evaluation | Adhesive strength index | 100 | 5 | 25 | 45 | 85 | 30 | 50 | 90 | 70 | 90 | 95 |
| | JIS-A hardness | 55 | 50 | 50 | 55 | 54 | 51 | 55 | 57 | 52 | 57 | 58 |
| | Static air pressure drop rate (%/month) | 3.7 | 2.3 | 2.4 | 2.5 | 2.6 | 2.4 | 2.5 | 2.9 | 2.4 | 2.5 | 2.7 |
| | Flex crack growth resistance index | 100 | 200 | 190 | 180 | 140 | 190 | 180 | 150 | 190 | 180 | 155 |

(*1) IIR: “Exxon chlorobutyl 1068” manufactured by Exxon Mobil Corporation

(*2) SIBS: “SIBSTAR 102T” manufactured by Kaneka Corporation (Shore A hardness: 25, styrene component content: 25% by mass)

(*3) LIR(1): “LIR-30” manufactured by Kuraray Co., Ltd. (liquid polyisoprene, weight-average molecular weight: 28000)

(*4) LIR(2): “LIR-403” manufactured by Kuraray Co., Ltd. (maleic anhydride-modified LIR, weight-average molecular weight: 34000, the number of maleic anhydrides per molecule: 3)

(*5) LIR(3): “LIR-410” manufactured by Kuraray Co., Ltd. (maleic acid-modified LIR, weight-average molecular weight: 30000, the number of maleic acid monomethyl esters per molecule: 10)

(*6) carbon: “Seast V” manufactured by Tokai Carbon Co., Ltd. (N660, N₂SA 27 m²/g)<

<Evaluation Results>

Samples 3 to 5 each represent an inner liner made of a polymer composition containing the SIBS and LIR, and a pneumatic tire using the same. These samples had improved adhesiveness with air permeation resistance being maintained, when compared with sample 2 having a polymer component made of 100% by mass of the SIBS.

Samples 6 to 8 each represent an inner liner made of a polymer composition containing the SIBS and maleic anhydride-modified LIR, and a pneumatic tire using the same. These samples had improved adhesiveness with air permeation resistance being maintained, when compared with sample 2 having a polymer component made of 100% by mass of the SIBS.

Samples 9 to 11 each represent an inner liner made of a polymer composition containing the SIBS and maleic acid-modified LIR, and a pneumatic tire using the same. These samples had improved adhesiveness with air permeation resistance being maintained, when compared with sample 2 having a polymer component made of 100% by mass of the SIBS.

Sample 2 represents a polymer composition for an inner liner having a polymer component made of 100% by mass of the SIBS, and a pneumatic tire using the same. Although sample 2 had excellent air permeation resistance, it had poor adhesiveness.

### Example 2

<Fabrication of Inner Liner>

According to each formulation shown in Table 2, compounding agents were charged into a twin-screw extruder (screw diameter: φ 50 mm; L/D: 30; cylinder temperature: 220° C.) to obtain pellets. Thereafter, a polymer sheet for an unvulcanized inner liner was fabricated with a T-die extruder (screw diameter: φ 80 mm; L/D: 50; die gap width: 500 mm; cylinder temperature: 220° C.; film gauge: 0.3 mm). The polymer sheet was used to perform the following tests.

<Adhesive Strength Test>

A rubber sheet with a thickness of 2 mm (formulation: NR/BR/SBR=40/30/30), a polymer sheet as the second layer, and a polymer sheet as the first layer were laminated in this order and vulcanized at 170° C. for 20 minutes to fabricate a sample for measuring adhesive strength. Vulcanization adhesive strength was obtained by measuring peel-off strength with a tensile tester. Based on the following calculation equation, vulcanization adhesive strength of each sample was expressed as an index, using the value of sample 29 as a reference value (100). It shows that the greater the vulcanization adhesive strength index is, the greater the vulcanization adhesive strength is.

(adhesive strength index)=(adhesive strength of each sample)/(vulcanization adhesive strength of sample 29)×100

Table 2 shows results.

<Manufacturing of Pneumatic Tire>

The above polymer sheets for the inner liner were used for an inner liner part of a tire of 195/65R15 size having a structure of FIG. 1 to manufacture a green tire, and then press vulcanization was performed at 170° C. for 20 minutes in the vulcanization step. Subsequently, the tire was cooled at 100° C. for 3 minutes without being taken out of a vulcanization mold, and thereafter the tire was taken out of the vulcanization mold. As a cooling medium, water was used. By adopting such a cooling step, a pneumatic tire having a thin inner liner with a thickness of 0.3 mm was able to be manufactured.

The resultant tire was used to perform the following tests.

<Flex Crack Growth Test>

A flex crack growth test was performed to make an evaluation based on whether or not the inner liner was broken or peeled off. Each tire was mounted on a JIS standard rim 15×6JJ, and the inside of the tire was monitored under the conditions of a tire internal pressure of 150 kPa, which was lower than usual, a load of 600 kg, a speed of 100 km/hour, and a driving distance of 20,000 km, to measure the numbers of cracks and peel-offs. Flex crack growth resistance of each sample was expressed as an index, using the value of sample 29 as a reference value. The greater the value of the index is, the less likely a crack is to occur, which is satisfactory.

(flex crack growth resistance index)=(the number of cracks in sample 29)/(the number of cracks in each sample)×100

<Rolling Resistance Test>

Each prototype tire was mounted on a JIS standard rim 15×6JJ, and rolling resistance was measured while driving the tire at room temperature (30° C.) under the conditions of a load of 3.4 kN, an air pressure of 230 kPa, and a speed of 80 km/hour, using a rolling resistance tester manufactured by KOBE STEEL, LTD. Based on the following calculation equation, a rolling resistance change rate (%) in each example was expressed as an index, using the value of sample 29 as a reference value (100). It shows that the greater the rolling resistance change rate is, the smaller the rolling resistance is.

rolling resistance change rate=(rolling resistance of sample 29/rolling resistance of each sample)×100

<Static Air Pressure Drop Rate Test>

A 195/65R15 steel radial PC tire was mounted on a JIS standard rim 15×6JJ, and an initial air pressure of 300 kPa was sealed therein. The tire was left at room temperature for 90 days and thereafter an air pressure drop rate was calculated. The smaller the value is, the less likely the air pressure is to be reduced.

Table 2 shows results.

TABLE 2

| | | Compounding agent | Sample | | | | | | | | | |
|---|---|---|---|---|---|---|---|---|---|---|---|---|
| | | (parts by mass) | 12 | 13 | 14 | 15 | 16 | 17 | 18 | 19 | 20 | 21 |
| Inner | First | SIBS⁽*²⁾ | 100 | 100 | 100 | 100 | 100 | 100 | 100 | 100 | 100 | 100 |
| liner | layer | LIR(1)⁽*³⁾ | — | — | — | — | — | — | — | — | 10 | 40 |
| | | LIR(2)⁽*⁴⁾ | — | — | — | — | — | — | — | — | — | — |
| | | LIR(3)⁽*⁵⁾ | 10 | 10 | 10 | 10 | 0.5 | 40 | 10 | 10 | — | — |
| | Second | SIS⁽*⁷⁾ | 90 | — | — | 20 | 20 | 20 | 100 | — | 20 | 90 |
| | layer | SIB⁽*⁸⁾ | — | 90 | 20 | — | — | — | — | 100 | — | — |
| | | SIBS⁽*²⁾ | 10 | 10 | 80 | 80 | 80 | 80 | — | — | 80 | 10 |

| | | | | | | | | | | | |
|---|---|---|---|---|---|---|---|---|---|---|---|
| Evaluation | Adhesive strength index | 105 | 105 | 155 | 155 | 100 | 110 | 73 | 73 | 90 | 95 |
| | Flex crack growth resistance index | 100 | 100 | 110 | 110 | 100 | 105 | 73 | 73 | 105 | 105 |
| | Rolling resistance change rate | 105 | 105 | 108 | 108 | 95 | 70 | 96 | 96 | 90 | 85 |
| | Static air pressure drop rate (%/month) | 1.7 | 1.7 | 1.5 | 1.5 | 1.5 | 2.0 | 2.6 | 2.6 | 1.6 | 1.8 |

| | | Compounding agent | Sample | | | | | | | | |
|---|---|---|---|---|---|---|---|---|---|---|---|
| | | (parts by mass) | 22 | 23 | 24 | 25 | 26 | 27 | 28 | 29 | 30 |
| Inner | First | SIBS⁽*²⁾ | 100 | 100 | 100 | 100 | 100 | 100 | 100 | 100 | 100 |
| liner | layer | LIR(1)⁽*³⁾ | 10 | — | — | — | — | — | — | — | — |
| | | LIR(2)⁽*⁴⁾ | 10 | 10 | 40 | — | — | — | — | — | — |
| | | LIR(3)⁽*⁵⁾ | — | — | — | — | — | — | — | — | — |
| | Second | SIS⁽*⁷⁾ | — | — | 20 | 100 | — | 90 | — | 20 | — |
| | layer | SIB⁽*⁸⁾ | 90 | 20 | — | — | 100 | — | 90 | — | 20 |
| | | SIBS⁽*²⁾ | 10 | 80 | 80 | — | — | 10 | 10 | 80 | 80 |

| | | | | | | | | | | |
|---|---|---|---|---|---|---|---|---|---|---|
| Evaluation | Adhesive strength index | 105 | 150 | 110 | 40 | 40 | 68 | 68 | 100 | 100 |
| | Flex crack growth resistance index | 103 | 108 | 106 | 67 | 67 | 87 | 87 | 100 | 100 |
| | Rolling resistance change rate | 100 | 110 | 68 | 94 | 94 | 99 | 99 | 100 | 100 |
| | Static air pressure drop rate (%/month) | 1.8 | 1.5 | 2.0 | 2.7 | 2.7 | 1.7 | 1.7 | 1.5 | 1.5 |

(*2) SIBS: “SIBSTAR 102T” manufactured by Kaneka Corporation (Shore A hardness: 25, styrene component content: 25% by mass, weight-average molecular weight: 100,000)

(*3) LIR(1): “LIR-30” manufactured by Kuraray Co., Ltd. (liquid polyisoprene, weight-average molecular weight: 28000)

(*4) LIR(2): “LIR-403” manufactured by Kuraray Co., Ltd. (maleic anhydride-modified LIR, weight-average molecular weight: 34000, the number of maleic anhydrides per molecule: 3)

(*5) LIR(3): “LIR-410” manufactured by Kuraray Co., Ltd. (maleic acid-modified LIR, weight-average molecular weight: 30000, the number of maleic acid monomethyl esters per molecule: 10)

(*7) SIS: “D1161JP” manufactured by Kraton Performance Polymers Inc. (styrene component content: 15% by mass, weight-average molecular weight: 150,000)

(*8) SIB: manufactured by a manufacturing method described below.

In a 2 L reaction vessel equipped with a stirrer, 589 mL of methylcyclohexane (dried over molecular sieves), 613 mL of n-butyl chloride (dried over molecular sieves), and 0.550 g of cumyl chloride were charged. After cooling the reaction vessel to −70° C., 0.35 mL of α-picoline (2-methylpyridine) and 179 mL of isobutylene were added. Further, 9.4 mL of titanium tetrachloride was added to start polymerization, and then the solution was reacted for 2.0 hours while being stirred at −70° C. Next, 59 mL of styrene was added into the reaction vessel and the reaction was continued for another 60 minutes, and then the reaction was terminated by adding a large amount of methanol. After removing the solvent and the like from the reaction solution, a polymer was dissolved in toluene and washed twice with water. This toluene solution was added to the methanol mixture, thereby precipitating the polymer, and the resultant polymer was dried at 60° C. for 24 hours to obtain a styrene-isobutylene diblock copolymer (styrene component content: 15% by mass, weight-average molecular weight: 70,000).

<Evaluation Results>

Each sample was evaluated by being compared with sample 29 having the first layer made of the SIBS only and the second layer made of 20% by mass of the SIS and 80% by mass of the SIBS.

Samples 12 to 15 and samples 22, 23 were excellent in adhesive strength of the inner liner, and flex crack growth resistance, rolling resistance, and air permeation resistance of the pneumatic tire, with air permeation resistance equal to that of sample 29 being maintained.

Samples 16, 20 had performance equal to that of sample 29 in every item.

In samples 17, 21, 24, the content of LIR, maleic anhydride-modified LIR, or maleic acid-modified LIR in the first polymer composition was 40 parts by mass relative to 100 parts by mass of the SIBS. These samples had increased rolling resistance when compared with sample 29.

In samples 18, 19, the second layer did not contain the SIBS. These samples had poor adhesive strength, flex crack growth resistance, rolling resistance, and air permeation resistance, when compared with sample 29.

In samples 25 to 28, the first layer did not contain any of LIR, maleic anhydride-modified LIR, and maleic acid-modified LIR. These samples had poor adhesive strength and flex crack growth resistance, when compared with sample 29.

Sample 30 had an effect equal to that of sample 29.

### Example 3

<Manufacturing of Inner Liner>

Compounding agents to be used to manufacture an inner liner were prepared as described below.

[SIB]

In a 2 L reaction vessel equipped with a stirrer, 589 mL of methylcyclohexane (dried over molecular sieves), 613 mL of n-butyl chloride (dried over molecular sieves), and 0.550 g of cumyl chloride were charged. After cooling the reaction vessel to −70° C., 0.35 mL of α-picoline (2-methylpyridine) and 179 mL of isobutylene were added. Further, 9.4 mL of titanium tetrachloride was added to start polymerization, and then the solution was reacted for 2.0 hours while being stirred at −70° C. Next, 59 mL of styrene was added into the reaction vessel and the reaction was continued for another 60 minutes, and then the reaction was terminated by adding a large amount of methanol. After removing the solvent and the like from the reaction solution, a polymer was dissolved in toluene and washed twice with water. This toluene solution was added to the methanol mixture, thereby precipitating the polymer, and the resultant polymer was dried at 60° C. for 24 hours to obtain a styrene-isobutylene diblock copolymer (styrene component content: 15% by mass, weight-average molecular weight: 70,000).

[SIBS]

“SIBSTAR 102 (Shore A hardness: 25, styrene component content: 25% by mass, weight-average molecular weight: 100,000)” manufactured by Kaneka Corporation was used.

[SIS]

“D1161JP (styrene component content: 15% by mass, weight-average molecular weight: 150,000)” manufactured by Kraton Performance Polymers Inc. was used.

[2-methylimidazole]

“Epicure MI-2 (2-methylimidazole)” manufactured by Yuka Shell Epoxy K. K. was used.

[Liquid Polyisoprene]

LIR(1): liquid polyisoprene (Kuraprene LIR-30 manufactured by Kuraray Co., Ltd., weight-average molecular weight: 28,000).

LIR(2): maleic acid-modified liquid polyisoprene (Kuraprene LIR-410 manufactured by Kuraray Co., Ltd., weight-average molecular weight: 30,000).

[Epoxidized Natural Rubber]

“ENR25 (epoxidation rate: 25 mol %)” manufactured by Kumpulan Guthrie Berhad was used.

According to each formulation shown in Tables 1 and 2, the compounding agents were charged into a twin-screw extruder (screw diameter: φ 50 mm; L/D: 30; cylinder temperature: 220° C.) to obtain pellets. Thereafter, an inner liner was fabricated with a T-die extruder (screw diameter: φ 80 mm; L/D: 50; die gap width: 500 mm; cylinder temperature: 220° C.; film gauge: 0.3 mm).

<Manufacturing of Pneumatic Tire>

To manufacture a pneumatic tire, the above inner liner was provided to a tire of 195/65R15 size having a basic structure shown in FIG. 1 to manufacture a green tire, and then press vulcanization was performed at 170° C. for 20 minutes in the vulcanization step. Subsequently, the tire was cooled at 100° C. for 3 minutes without being taken out of a vulcanization mold, and thereafter the tire was taken out of the vulcanization mold. As a cooling medium, water was used. By adopting such a cooling step, the inner liner was able to have a thickness of 0.3 mm.

<Performance Test>

Performance evaluation was performed on each inner liner and pneumatic tire, in the following manner.

<Vulcanization Adhesive Strength>

An unvulcanized inner liner and an unvulcanized rubber sheet (formulation: NR/BR/SBR=40/30/30) for a carcass ply layer were laminated such that the second layer contacted the carcass ply layer, and vulcanized at 170° C. for 20 minutes, to fabricate a sample for measuring vulcanization adhesive strength. Vulcanization adhesive strength was obtained by measuring peel-off strength with a tensile tester. Based on the following calculation equation, vulcanization adhesive strength of each example and comparative example was expressed as an index, using the value of Comparative Example 3-15 as a reference value. It shows that the greater the vulcanization adhesive strength index is, the greater the vulcanization adhesive strength is.

vulcanization adhesive strength index=(vulcanization adhesive strength of each example and comparative example)/(vulcanization adhesive strength of Comparative Example 3-15)×100

<Flex Crack Growth Test>

A flex crack growth test was performed to make an evaluation based on whether or not the inner liner was broken or peeled off. Each prototype tire was mounted on a JIS standard rim 15×6JJ, and the inside of the tire was monitored under the conditions of a tire internal pressure of 150 kPa, which was lower than usual, a load of 600 kg, a speed of 100 km/hour, and a driving distance of 20,000 km, to measure the numbers of cracks and peel-offs. Crack growth property of each example and comparative example was expressed as an index, using the value of Comparative Example 3-15 as a reference value. It shows that the greater the value of the index is, the less likely the flex crack growth is to occur.

flex crack growth property index=(the numbers of cracks and peel-offs in Comparative Example 3-15)/(the numbers of cracks and peel-offs in each example and comparative example)×100

<Rolling Resistance Index>

Each prototype tire was mounted on a JIS standard rim 15×6JJ, and rolling resistance was measured while driving the tire at room temperature (30° C.) under the conditions of a load of 3.4 kN, an air pressure of 230 kPa, and a speed of 80 km/hour, using a rolling resistance tester manufactured by KOBE STEEL, LTD. Based on the following calculation equation, a rolling resistance change rate (%) in each example and comparative example was expressed as an index, using the value of Comparative Example 3-15 as a reference value (100). It shows that the greater the rolling resistance change rate is, the smaller the rolling resistance is.

rolling resistance index=(rolling resistance of Comparative Example 3-15/rolling resistance of each example and comparative example)×100

<Static Air Pressure Drop Rate Test>

Each prototype tire was mounted on a JIS standard rim 15×6JJ, and an initial air pressure of 300 kPa was sealed therein. The tire was left at room temperature for 90 days and thereafter an air pressure drop rate was calculated. The smaller the value is, the less likely the air pressure is to be reduced.

TABLE 3

| | | | Comparative Example | | | | | | | | | |
|---|---|---|---|---|---|---|---|---|---|---|---|---|
| | | | 3-1 | 3-2 | 3-3 | 3-4 | 3-5 | 3-6 | 3-7 | 3-8 | 3-9 | 3-10 |
| Inner | First | SIBS | 100 | 100 | 100 | 100 | 100 | 100 | 100 | 100 | 100 | 100 |
| liner | layer | LIR(1) | — | — | — | — | — | — | 10 | — | — | — |
| | (parts by | LIR(2) | — | — | — | — | — | — | — | 0.5 | 40 | 10 |
| | mass) | 2-methylimidazole | — | — | — | — | — | — | — | — | — | — |
| | Second | SIS | 100 | — | 90 | — | 20 | — | 20 | 20 | 20 | 100 |
| | layer | SIB | — | 100 | — | 90 | — | 20 | — | — | — | — |
| | (parts by | Epoxidized natural rubber | — | — | — | — | — | — | — | — | — | — |
| | mass) | SIBS | — | — | 10 | 10 | 80 | 80 | 80 | 80 | 80 | — |

| | | | | | | | | | | | |
|---|---|---|---|---|---|---|---|---|---|---|---|
| Tire | Vulcanization adhesive strength index | 26 | 26 | 44 | 44 | 65 | 65 | 58 | 65 | 71 | 47 |
| test | Flex crack growth property index | 61 | 61 | 79 | 79 | 91 | 91 | 95 | 91 | 95 | 66 |
| | Rolling resistance change rate | 87 | 87 | 92 | 92 | 93 | 93 | 83 | 88 | 65 | 89 |
| | Static air pressure drop rate (%/month) | 2.7 | 2.7 | 1.7 | 1.7 | 1.5 | 1.5 | 1.6 | 1.5 | 2.0 | 2.6 |

| | | | Comparative Example | | | | | | | | |
|---|---|---|---|---|---|---|---|---|---|---|---|
| | | | 3-11 | 3-12 | 3-13 | 3-14 | 3-15 | 3-16 | 3-17 | 3-18 | 3-19 |
| Inner | First | SIBS | 100 | 100 | 100 | 100 | 100 | 100 | 100 | 100 | 100 |
| liner | layer | LIR(1) | — | — | — | — | — | — | — | — | — |
| | (parts by | LIR(2) | 10 | 10 | 10 | 10 | 10 | 10 | 10 | 10 | 10 |
| | mass) | 2-methylimidazole | — | — | — | — | — | 15 | 3 | 0.05 | 3 |
| | Second | SIS | — | 90 | — | — | 20 | 80 | 40 | 80 | 88 |
| | layer | SIB | 100 | — | 90 | 20 | — | — | — | — | — |
| | (parts by | Epoxidized natural rubber | — | — | — | — | — | 10 | 50 | 10 | 2 |
| | mass) | SIBS | — | 10 | 10 | 80 | 80 | 10 | 10 | 10 | 10 |

| | | | | | | | | | | |
|---|---|---|---|---|---|---|---|---|---|---|
| Tire | Vulcanization adhesive strength index | 47 | 68 | 68 | 100 | 100 | 115 | 105 | 100 | 100 |
| test | Flex crack growth property index | 66 | 91 | 91 | 100 | 100 | 100 | 105 | 100 | 100 |
| | Rolling resistance change rate | 89 | 97 | 97 | 100 | 100 | 95 | 90 | 100 | 100 |
| | Static air pressure drop rate (%/month) | 2.6 | 1.7 | 1.7 | 1.5 | 1.5 | 1.3 | 1 | 1.5 | 1.5 |

TABLE 4

| | | | Example | | | | | |
|---|---|---|---|---|---|---|---|---|
| | | | 3-1 | 3-2 | 3-3 | 3-4 | 3-5 | 3-6 |
| Inner | First | SIBS | 100 | 100 | 100 | 100 | 100 | 100 |
| liner | layer | LIR(1) | — | — | — | — | — | — |
| | (parts by | LIR(2) | 10 | 10 | 10 | 10 | 10 | 10 |
| | mass) | 2-methylimidazole | 3 | 5 | 3 | 5 | 3 | 3 |
| | Second | SIS | 80 | 80 | 70 | 70 | — | 10 |
| | layer | SIB | — | — | — | — | 10 | — |
| | (parts by | Epoxidized natural rubber | 10 | 10 | 20 | 20 | 10 | 10 |
| | mass) | SIBS | 10 | 10 | 10 | 10 | 80 | 80 |

| | | | | | | | |
|---|---|---|---|---|---|---|---|
| Tire | Vulcanization adhesive strength index | 115 | 120 | 120 | 125 | 145 | 140 |
| test | Flex crack growth property index | 105 | 105 | 110 | 110 | 125 | 120 |
| | Rolling resistance change rate | 100 | 100 | 100 | 100 | 110 | 105 |
| | Static air pressure drop rate (%/month) | 1.7 | 1.7 | 1.7 | 1.7 | 1.7 | 1.7 |

<Evaluation Results>

Each of the examples and the comparative examples was evaluated by being compared with Comparative Example 3-15 (having the first layer containing 100 parts by mass of the SIBS and 10 parts by mass maleic acid-modified LIR, and the second layer containing 20 parts by mass of the SIS and 80 parts by mass of the SIBS).

Examples 3-1 to 3-6 had the first layer containing 3 to 5 parts by mass of 2-methylimidazole, and the second layer containing 10 to 20 parts by mass of epoxidized natural rubber. They had improved adhesiveness and flex crack growth resistance and decreased rolling resistance, with air permeation resistance equal to that of Comparative Example 3-15 being maintained.

In Comparative Examples 3-1 and 3-2, the second layer did not contain the SIBS. They had poor vulcanization adhesive strength, when compared with Comparative Example 3-15.

In Comparative Examples 3-3 to 3-7, the first layer did not contain maleic acid-modified LIR. They had poor vulcanization adhesive strength, when compared with Comparative Example 3-15.

In Comparative Example 3-8, the first layer contained 0.5 parts by mass of maleic acid-modified LIR. It had poor vulcanization adhesive strength, when compared with Comparative Example 3-15.

In Comparative Example 3-9, the first layer contained 40 parts by mass of maleic acid-modified LIR. It had increased rolling resistance, when compared with Comparative Example 3-15.

In Comparative Examples 3-10 and 3-11, the second layer did not contain the SIBS. They had poor vulcanization adhesive strength, when compared with Comparative Example 3-15.

Comparative Examples 3-12 to 3-14 and 3-16 to 3-19 exhibited performances equal to those of Comparative Example 3-15.

### INDUSTRIAL APPLICABILITY

The pneumatic tire in accordance with the present invention is applicable to pneumatic tires for passenger cars, trucks and buses, lightweight trucks, and heavy vehicles.

Although the embodiments of the present invention have been described, it should be understood that the embodiments disclosed herein are illustrative and non-restrictive in every respect. The scope of the present invention is defined by the scope of the claims, and is intended to include any modifications within the scope and meaning equivalent to the scope of the claims.

What is claimed is:

1. A pneumatic tire comprising an inner liner on a tire inner side of a carcass ply laid between a pair of bead parts,
said inner liner having a first layer made of a first polymer composition,
said first polymer composition containing not less than 0.5 parts by mass and not more than 70 parts by mass of at least one selected from the group consisting of liquid polyisoprene, a maleic anhydride adduct of liquid polyisoprene, and a maleic acid monomethyl ester adduct of liquid polyisoprene, relative to 100 parts by mass of a styrene-isobutylene-styrene triblock copolymer.

2. A pneumatic tire comprising an inner liner on a tire inner side of a carcass ply laid between a pair of bead parts,
said inner liner having a first layer made of a first polymer composition and a second layer made of a second polymer composition,
said first polymer composition containing not less than 0.5 parts by mass and not more than 35 parts by mass of at least one selected from the group consisting of liquid polyisoprene, a maleic anhydride adduct of liquid polyisoprene, and a maleic acid monomethyl ester adduct of liquid polyisoprene, relative to 100 parts by mass of a styrene-isobutylene-styrene triblock copolymer,
said second polymer composition containing not less than 10% by mass and not more than 80% by mass of a styrene-isobutylene-styrene triblock copolymer in a polymer component,
said second layer being arranged to contact said carcass ply.

3. The pneumatic tire according to claim 2, wherein said second polymer composition contains at least one of a styrene-isoprene-styrene triblock copolymer and a styrene-isobutylene diblock copolymer.

4. The pneumatic tire according to claim 1, wherein the number of maleic acid monomethyl esters per molecule in said maleic acid monomethyl ester adduct of liquid polyisoprene is not less than 1 and not more than 20, and said maleic acid monomethyl ester adduct of liquid polyisoprene has a weight-average molecular weight of not less than 5,000 and not more than 50,000.

5. The pneumatic tire according to claim 1, wherein the number of maleic anhydrides per molecule in said maleic anhydride adduct of liquid polyisoprene is not less than 1 and not more than 20, and said maleic anhydride adduct of liquid polyisoprene has a weight-average molecular weight of not less than 5,000 and not more than 50,000.

6. A pneumatic tire comprising an inner liner on a tire inner side of a carcass ply laid between a pair of bead parts,
said inner liner including a first layer arranged on the tire inner side and a second layer arranged to contact a rubber layer of said carcass ply,
said first layer being made of a first thermoplastic elastomer composition,
said first thermoplastic elastomer composition containing not less than 90% by mass of a styrene-isobutylene-styrene triblock copolymer in a thermoplastic elastomer component, and containing not less than 0.1 parts by mass and not more than 35 parts by mass of liquid polyisoprene having a carboxyl group and not less than 0.1 parts by mass and not more than 10 parts by mass of imidazoles, relative to 100 parts by mass of said thermoplastic elastomer component,
said second layer being made of a second thermoplastic elastomer composition,
said second thermoplastic elastomer composition containing not less than 10% by mass and not more than 80% by mass of a styrene-isobutylene-styrene triblock copolymer in a thermoplastic elastomer component, and containing not less than 5 parts by mass and not more than 30 parts by mass of epoxidized diene-based rubber relative to 100 parts by mass of said thermoplastic elastomer component.

7. The pneumatic tire according to claim 6, wherein said imidazoles are 2-methylimidazole.

8. The pneumatic tire according to claim 6, wherein said second thermoplastic elastomer composition contains at least one of a styrene-isoprene-styrene triblock copolymer and a styrene-isobutylene diblock copolymer.

9. The pneumatic tire according to claim 2, wherein said first layer has a thickness of not less than 0.05 mm and not more than 0.6 mm, and said second layer has a thickness of not less than 0.01 mm and not more than 0.3 mm.

10. The pneumatic tire according to claim 1, wherein said styrene-isobutylene-styrene triblock copolymer has a styrene component content of not less than 10% by mass and not more than 30% by mass, and a weight-average molecular weight of not less than 50,000 and not more than 400,000.

11. The pneumatic tire according to claim 3, wherein said styrene-isoprene-styrene triblock copolymer has a styrene component content of not less than 10% by mass and not more than 30% by mass, and a weight-average molecular weight of not less than 100,000 and not more than 290,000.

12. The pneumatic tire according to claim 3, wherein said styrene-isobutylene diblock copolymer has a linear chain, a styrene component content of not less than 10% by mass and not more than 35% by mass, and a weight-average molecular weight of not less than 40,000 and not more than 120,000.
